(19) United States
(12) Patent Application Publication
(10) Pub. No.: US 2010/0243816 A1
(43) Pub. Date: Sep. 30, 2010

(54) Aircraft also called a spacecraft, an aerospace craft, or a submersible craft

(76) Inventor: Gary Richard Gochnour, (US)

Correspondence Address: Gary Richard Gochnour, 747 N. 135th St, Apt 426, Seattle, WA, 98133, US

(21) Appl. No.: 12/661,559

(22) Filed: Mar. 19, 2010

Related U.S. Application Data
(62) Division of application No. 11/728,080, filed on Mar. 23, 2007.
Application No. 11/728,080 is a continuation-in-part of application No. 11/137,643, filed on May 25, 2005, now abandoned.
Application No. 11/137,643 is a continuation-in-part of application No. 10/841,702, filed on May 6, 2004, now abandoned.
(60) Provisional application No. 60/468,598, filed on May 6, 2003.

(51) Int. Cl. B64G 1/40

(52) U.S. Cl. 244/171.5

(57) ABSTRACT

The invention relates to a plasma based aircraft maintained in a flight mode by rotating plasma vortices located above and beneath said aircraft. Said aircraft is comprised of chromium steel, or higher ferrochromium steel can be used. Said aircraft receives energy from aircraft produced plasma obtained from the atmosphere.

Produced energy is stored within craft oscillatory circuit and plasma vortices. When energy from craft capacitance system is depleting, energy can be obtained from craft inductance system from craft magnetic field.

Said craft is capable of space flight, use as a submersible craft, boring device, or lifting device. Particle propulsion in space will be accomplished utilizing metal ions stored within craft capacitor plates.

Said craft is opaque to electromagnetic radiation, and also absorbs radiation directed at craft.

Said craft is capable of verticle ascent, descent and landing, and is lenticular in shape.

Said aircraft can operate within earth radiation belts safely.

### CROSS-REFERENCE TO RELATED APPLICATIONS

This application is a division of application Ser. No. 11/728,080 filed Mar. 23, 2007, by present inventor, now abandoned, which was a continuation in part of Ser. No. 11/137,643, filed May 25, 2005 by present inventor, now abandoned, which was a continuation in part of Ser. No. 10/841/702, filed 2004, May 6, by present inventor, now abandoned, which claims the priority to provisional patent application with Ser. No. 60/468,598, filed 2003, May 6, by the present inventor.

### BACKGROUND OF THE INVENTION

### Field of Invention

### Aircraft

This invention relates to a new type multi-functional electromagnetic, plasma based aircraft, capable of operation in the atmosphere as an aircraft, underwater as a submersible craft, in outer space as a space craft, or as a boring device, or a lifting device.

This invention will make possible travel in space at small cost. Depletion of the world's resources will no longer be a problem. This invention is on a par with the discovery of fire, insofar as man's future is concerned, and is also a decontamination device.

### SUMMARY OF THE INVENTION

In the present invention, an aircraft operates within a plasma environment of charged particles, said particles are rotating around the craft within an atmosphere.

In immediate outer space, the exosphere and above, and within outer space, an alternative propulsion system will be used.

within an atmosphere of gases, the aircraft operations will be performed in a hyperdynamic plasma state.

In the aircraft of present invention, charged particles will be produced off an annular ring of blades around aircraft, primarily from conducting wires heated to high temperatures due to resistance. Departing particles will interact with the ambient atmosphere producing more ions. A large quantity of plasma will be produced off the ring of blades. Individual blades within the annular ring of blades around the circumferential midsection, of the aircraft, possess conducting, uninsulated field windings, comprised of the material tungsten, in preferred embodiment.

In the present invention, charged particles comprising electrons and charged ions, also called energetic charged particles will be placed into Larmor gyro orbiting particle fields around the aircraft, as rotating plasma vortices.

Said orbiting particle fields, rotating, circling said ferromagnetic aircraft, will raise the aircraft to high magnetic fields, and consequent high electric and plasma fields.

In the present invention, an orbiting particle field, possessing a rotational direction for upward motional movement, and utilizing an extensive array of capacitors, will lift the aircraft off the ground, or other surface, into the air.

In the present invention, navigation of the aircraft will be by means of utilizing said blades, as ailerons. Said ailerons wrapped by said conducting field windings possess an electric charge within the orbiting particle fields, and by use of rotating plasma vortices for propulsion, the aircraft will be placed in direction of travel by means of the ailerons.

In the present invention, only remnant energy from last operation of aircraft, said remnant energy stored in craft oscillatory circuit, sufficient to begin operation of craft, will be required to start aircraft. No fuel is required, only energy from air.

In the present invention, the aircraft will produce all the energy required to operate aircraft from aircraft plasma fields, and oscillatory circuit, to include producing said energy.

In the present invention, the aircraft, can produce electric energy.

In this invention, the aircraft can be used as an aircraft, spacecraft, submersible craft, boring or lifting device, or by a particle propulsion system in space, this aircraft can regularly journey to Mars and some of the asteroids in the asteroid belt, at, in effect, negligible, or no cost.

### BRIEF DESCRIPTION OF THE DRAWINGS

FIG. 1 is a side view of the aircraft showing lenticular shape of aircraft. Also shown is a side view of the annular bladed ring assembly encircling the aircraft and extending out from the sides of the aircraft, three landing gear, a window for pilot and copilot, and the top and bottom plasma vortices.

FIG. 2 is a top plan view of the aircraft showing the circular configuration of aircraft, and the annular bladed ring assembly.

FIG. 3 is a bottom plan view of the aircraft showing the circular configuration of aircraft, the bottom of the annular bladed ring assembly, the three landing gear, and a soft-landing, surface on bottom of aircraft. Also shown weak current entrance and strong current exit. Field windings are shown in a longitudinal position, a blade core for field windings is shown, and blade notches for field windings on a blade.

FIG. 4 is a top plan view showing capacitor, electric system attached to top plan surface of bottom half of aircraft hull, and the same top plan view showing the top of annular bladed ring assembly.

FIG. 5 is a cross section side view of the aircraft showing an ion acceleration system and the central shaft containing an inductance coil, annular bladed ring assembly, capacitor system, electrolysis system, crew cabin doors for access to upper deck and lower deck through said central shaft, crew hatch doors for entering or exiting craft through the central shaft, and a pilot area and pilot aircraft controls, and an engineer area and diagnostic controls for plasma and electric systems.

FIG. 6A is a diagram showing the space between the upper and lower hulls for attachment of ailerons to multi-bladed annular ring.

FIG. 6B is a side view of the opening between the aircraft hulls to extract worn or burnt ailerons, or to attach replacement ailerons.

FIG. 6C is a side view of the aircraft using particle impact on ailerons to determine banking direction.

FIG. 6D is a side view of the aircraft using particle impact on ailerons to determine banking direction.

FIG. 6E is a side view of the aircraft. The charged particles are impacting ailerons on bottom surface. The aircraft will rise in altitude.

FIG. 6F is a side view of the aircraft using particle impact on ailerons to determine altitude direction. Particles will impact top surface of ailerons. The aircraft will descend.

FIG. 7A is a side view of an aircraft within rotating vortices. Ailerons have determined the position for direction of travel. Increase in rotation of vortices will propel the aircraft diagonal to earth.

FIG. 7B is a side view of an aircraft within rotating vortices being propelled horizontal with earth.

FIG. 7C is a side view of an aircraft within rotating vortices. Increase in rotation of vortices will propel the aircraft vertical to earth.

FIG. 8A is a top view of the extricated capacitor system from aircraft, showing combined negative charge of capacitors used as electrodes for propulsion, is moving aircraft away from lesser positive charged electrode, in direction of arrow.

FIG. 8B is a top view of extricated capacitor system for aircraft. Combined positive charge greater than negative is moving craft away from negative charge in direction of arrow.

FIG. 9D shown is a cutaway top view of aircraft used as a space craft. Utilizing alternating current from the fluctuating direct current of the aircraft, charged particles will be ejected from aircraft utilizing propulsion tube between a large and a small capacitor, as shown. Movement will be in direction of arrows.

FIG. 9E shown is a cutaway top view of aircraft used as a submersible craft within water. Ions off uninsulated conducting ailerons used as fixed rotating propellers will interact with surrounding conducting water with a Lorentz force propelling aircraft by synchronous movement of propellers in desired direction of travel.

FIG. 9F shown is a side view of aircraft used as a boring device with a protruding, rotating drill attached through center of craft.

FIG. 9G is a side view of craft used as a lifting device. Cables are hung from below blade assembly ring, to hoist load.

FIG. 10 is a side view of aircraft in electric force propulsion mode interacting with Earth's magnetic field.

### DESCRIPTION OF THE PREFERRED EMBODIMENT

### Operation of Aircraft

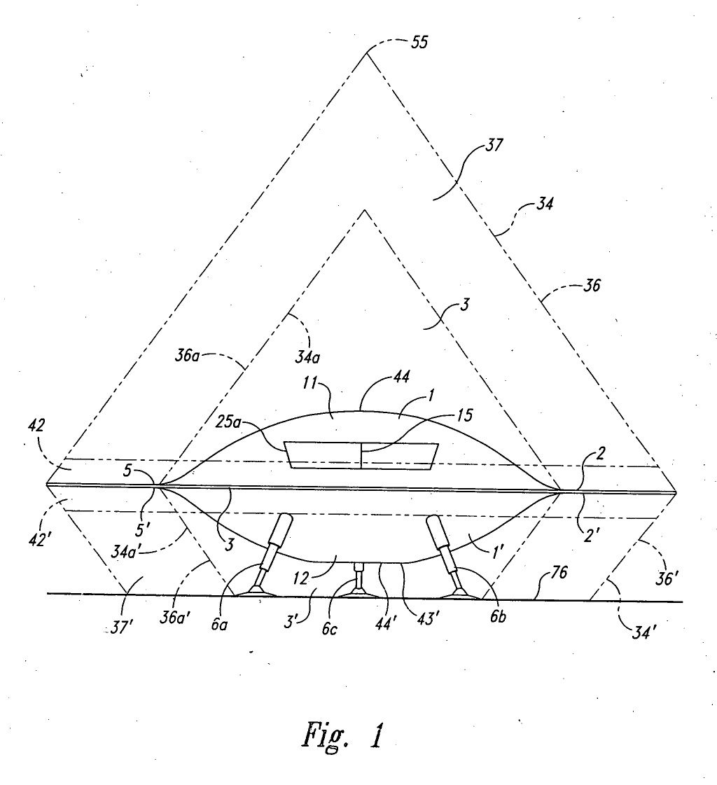

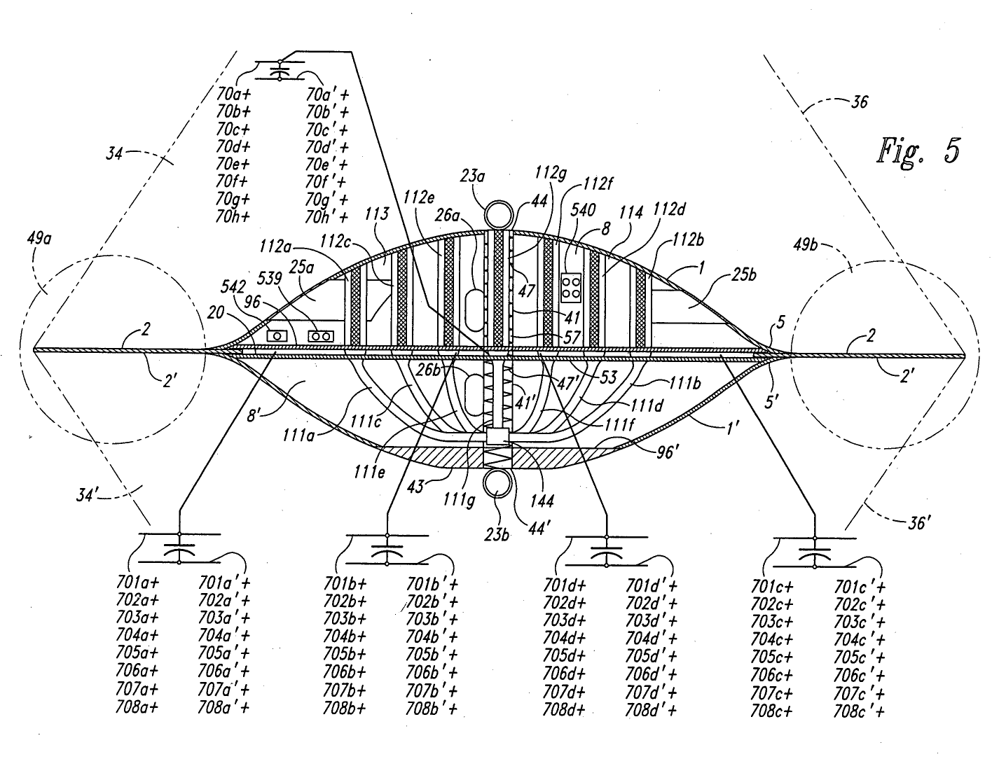

The operation of the aircraft as a system and device will be described first. Said aircraft being the central device. This will be followed by a description of the preferred embodiment pertaining to aircraft. Next a process portion of this utility patent will describe a process producing rotating plasma vortices 34, 34′ and 34a, 34a′, FIG. 1, on the top and bottom surfaces of an annular ring of blades 2, 2′, FIG. 1, around said aircraft. Said processes will be described first, followed by descriptions relating to the preferred embodiment for referenced processes. The aircraft is comprised of the material chromium steel in present invention, higher ferrochromium steel is also a recommended material for said aircraft. When starting operation, the remnant magnetism in the ferromagnetic hull 1, 1′, FIG. 1 of said craft 1, 1′, will be further magnetized from an array of capacitors FIG. 5 connected in parallel within an oscillatory circuit containing inductance and resistance. Said resistance being provided by uninsulated tungsten field windings around blade cores, connected to insulated copper wiring, preferred embodiments for wiring as specified.

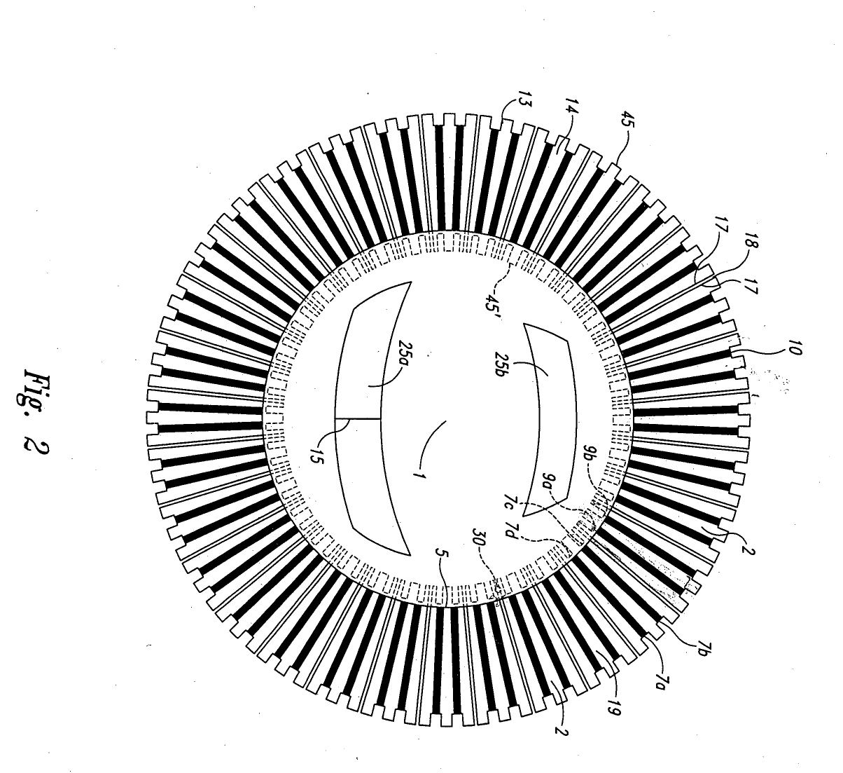

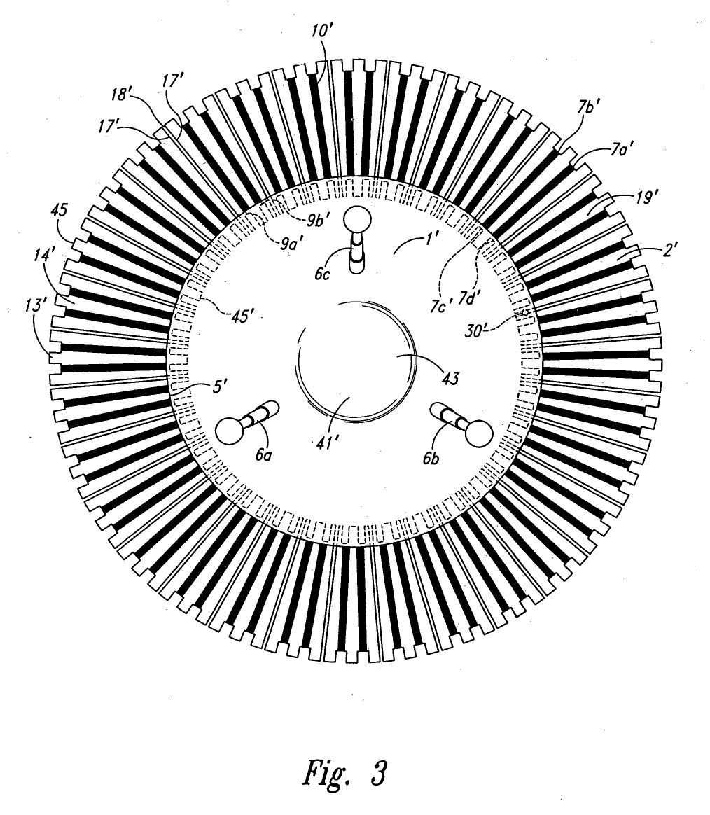

Said starting charge from the capacitors through the inductance coil, establishes an applied magnetic field around the aircraft, with a north pole 11, FIG. 1, and a south pole 12, FIG. 1, around the aircraft. At the same time, said capacitor system will provide a weak current 9a and 9b′, FIGS. 2 and 3, through uninsulated field windings 10, 10′, FIGS. 2 and 3, around blade cores 19, 19′, FIGS. 2 and 3, within an array of blades 2, 2′, FIGS. 2 and 3, encircling the aircraft. Thirty two blades is preferred embodiment for the number of blades in said annular ring of blades. Tungsten material is preferred embodiment for material for said field winding wire, producing a large number of free ions on uninsulated wire surfaces of the field windings.

Ions will be freed with current through said uninsulated field windings.

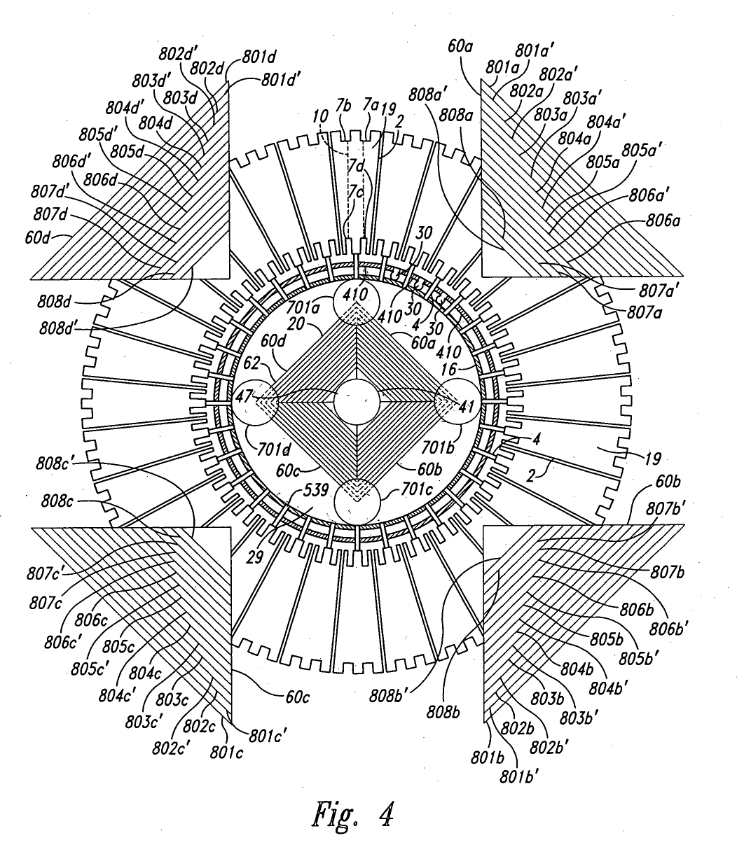

Said ions will be produced in abundance off the tungsten field windings. Said tungsten wire will be raised to high temperatures due to resistance within the tungsten field windings, the current into the tungsten wire coming from the more conductive copper wire in the electric system 20, FIG. 4.

Upon being energized by said current, the ions will depart the annular ring of blades at a voltage recognized to energize ions, mostly.

As the craft has a developed magnetic and electric field, said fields being at right angles to each other, the ions will be projected by a Lorentz force at right angles to the magnetic and electric fields, said fields being at right angles to each other, and then projected into perpendicular Larmor gyro orbiting fields, forming vortices 34, 34a, and 34′, 34a′, FIG. 5, around aircraft.

The more energetic particles will manifest narrowing orbits, over time, within the Larmor plasma particle fields, contributing to forming funnel shaped plasma vortices.

Said plasma vortices will form on both the top and bottom surfaces of said annular bladed ring assembly 2, 2′, FIGS. 2 and 3.

Due to a stronger electrical capacitance system within the oscillatory circuit than the magnetic based inductance system, and due to the diamagnetic plasma current to the right, the positive particles, protons will be pulled to the right. When viewing both the top plasma vortex and the bottom plasma vortex, from the ground looking up, both vortices will be turning clockwise. By the right hand rule, this is a motional direction of movement for upward movement, craft will lift off the earth and become airborne. The ailerons will be used to point the aircraft in the desired direction of travel. The electrical system will impart increased energy to the plasma vortices, and through increased current through the annular bladed ring assembly 2, 2′, aircraft will accelerate in desired direction of travel.

The Larmor gyro orbiting particle field is also a plasma field, a diamagnetic, moving magnetic field. Said fields form the rotating funnel shaped plasma vortices 34, 34a, and 34′, 34a′, FIG. 1. The top surface of the bottom funnel shaped plasma vortice 34′ and 34a′, and the bottom surface of the top funnel shaped plasma vortice 34 and 34a, FIG. 1, passing over the top and bottom surfaces of said conducting field windings 10, FIG. 2, and 10′, FIG. 3, on said fixed array of blades, generates electricity. Said field windings also conduct the alternating current component of the flux of the fluctuating direct current of the fixed poles of aircraft magnetic field as well as the flux of the moving diamagnetic plasma current.

The strong current exiting 9b, FIG. 2, will be stored within the aircraft capacitance inductance system.

Said aircraft also possesses an oscillatory circuit. Usually an oscillatory circuit loses energy as it emits some, or all energy as electromagnetic radiation out the ends of the inductance coil. Within this system, the aircraft plasma systems and oscillatory circuit, the overarching plasma vortices 34, 34′ and 34a, 34a′, FIG. 1, covered by a Langmuir sheath 36, 36′ and 36a, 36a′, FIG. 1, will reabsorb this radiation, the emitted radiation 44, 44′, FIG. 5.

The area under the plasma vortices is a vacuum area, extending from the inside surface of the plasma, 36a, 36a′, FIG. 1, to the hull surface, 1, 1′, FIG. 1. The radiation emitted from the inductance coil 47, 47′, FIG. 5, also called electric coil, is usually lost in whole, or in part. Within this system said emitted radiation 44, 44′, FIG. 5, is reabsorbed in its entirety. Plasmas absorb all electromagnetic radiation, to include the radiation they produce, they will be invisible to the human eye within the visible spectrum. Plasmas are opaque to electromagnetic radiation except by the magnetic poles of the craft where the light is polarized.

Said aircraft does not require fuel to be provided for aircraft to operate. Energy is obtained nondepleting from the atmosphere or the environment as electrons and ions.

The Larmor orbiting particles, a diamagnetic moving plasma, are in orbits around the aircraft, increasing in energy to the speed of light. Said rotating plasma field is part of the oscillatory circuit of the craft. Said plasma is an oscillatory, inhomogeneous plasma, similar to a magnetically contained, confined, homogeneous plasma, in that both fields can contain a spherical plasma. The magnetically confined spherical plasma for a transitory period of time, the oscillatory, inhomogeneous plasma, for much longer. Nonhyperdynamic equations from craft electromagnetic oscillatory system, can be used in lieu of the unascertainable equations of the hyperdynamic, inhomogeneous plasma, to control the field.

Both oscillatory systems, the electric capacitor system, and the magnetic inductance system, are connected. Also connected are the plasma vortices through the common annular bladed ring system with its uninsulated field windings, and the inductance system.

Said field windings connect both systems, the oscillatory circuit and the plasma vortices. The electromagnetic equations from the oscillatory circuit can be used to control the rotating plasma vortices as the plasma equations are hyperdynamic and not subject to control at this time. In effect, the plasma equations are unascertainable at this time due to multiple factors at or near the speed of light.

Energy can be taken out of the rotating plasma vortices, and placed into the capacitance inductance system, or conversely, energy can be taken out of the capacitance inductance system, and placed into said rotating plasma vortices. An increase of energy to the vortices, increases speed of craft, a decrease of energy, decreases speed. An increase in energy to vortices leads to an increase in rotation of the aircraft vortices, which leads to an increase in speed of craft. It also leads to a lengthening of the plasma vortices. The capacitance electric system controls the plasma vortices. The plasma gun assists propulsion as needed.

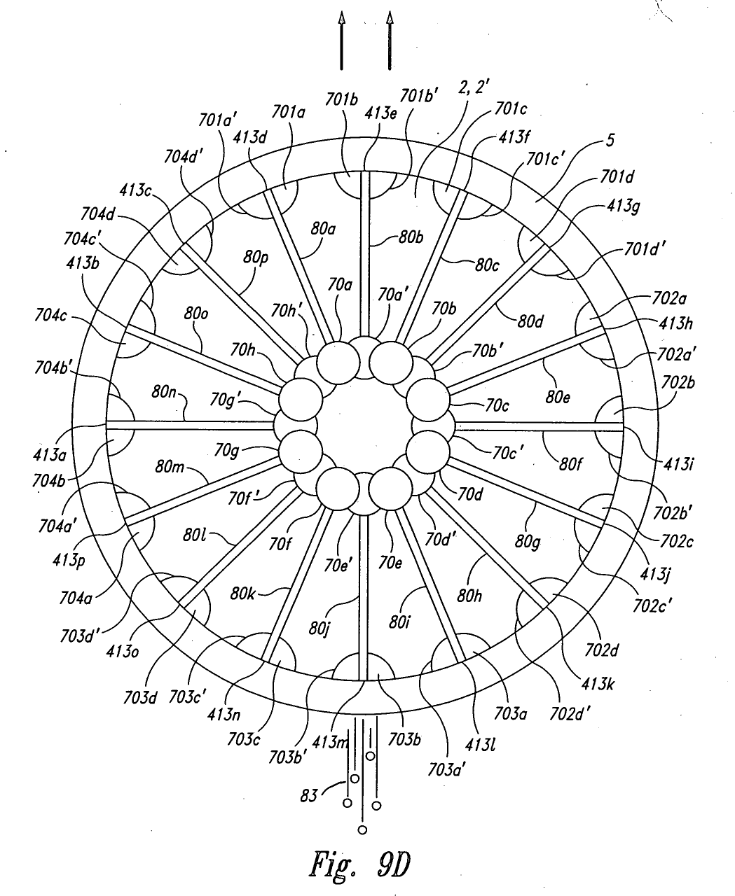

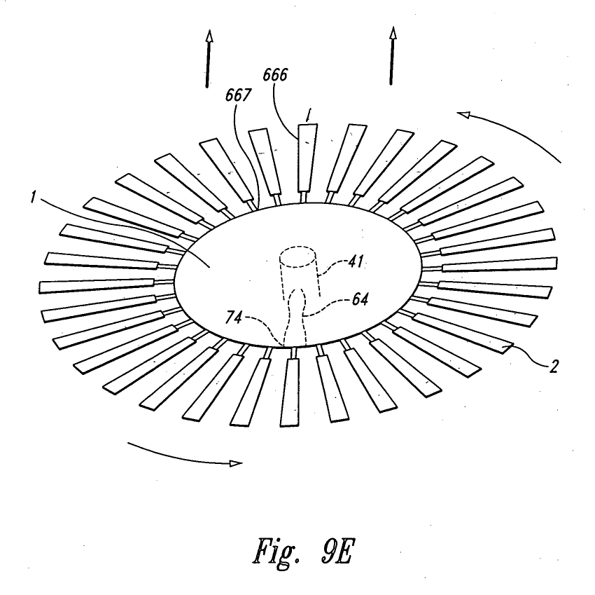

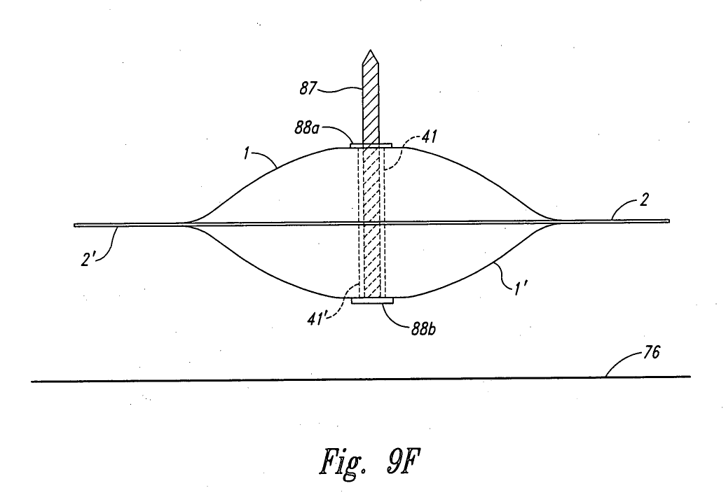

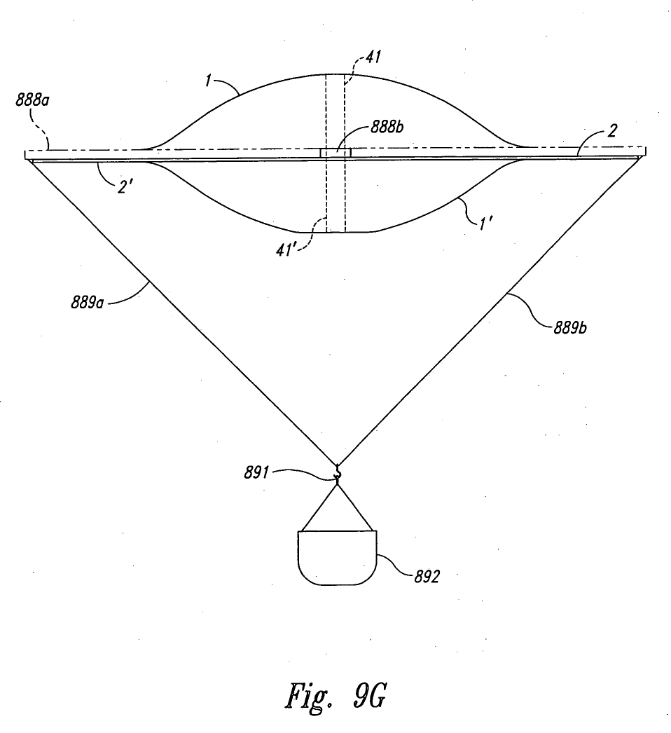

The preferred embodiment for the capacitors in the capacitance system is four sets of eight large capacitors connected in parallet as shown in FIGS. 4 and 5, a total of 64 capacitor plates, or 32 sets. Though four sets of eight capacitors is only four times as great as one set of eight capacitors, it has 40 times as much magnetic force when said capacitors are connected in parallel. An array of the top capacitors is depicted in FIG. 4, capacitors 701a, 701b, 701c, and 701d. Additionally, eight smaller capacitors 70a, 70b, 70c, 70d, 70e, 70f, and 70h, are depicted arrayed around central shaft 41, FIG. 9, and are also shown in FIG. 5. Eight small capacitors is preferred number of small capacitors.

The following aircraft systems will be connected in sequence: Bladed ring assembly 2, 2′, FIGS. 2 and 3, blade axel system 4, FIG. 4, a blade attachment ring 16, FIG. 4, the plurality of large capacitors 701a, 701b, 701c, 701d and 702a, 702b, 702c, 702d, and 703a, 703b, 703c, 703d, and 704a, 704b, 704c, 704d, and 705a, 705b, 705c, 705d, and 706a, 706b, 706c, 706d, and 707a, 707b, 707c, 707d, and 708a, 708b, 708c, and 708d, FIG. 5 and small capacitors 70a, 70b, 70c, 70d, 70e, 70f, 70g, 70h, inductance coil, also called electric coil 47, 47′, FIG. 5, and the interconnected electric system 20, FIGS. 4 and 5. Said electric coil will be comprised of thick coils. Thick metallic coils are preferred embodiment.

Electromagnetic radiation 44, 44′, FIG. 5, emitted from top and bottoms of craft from inductance coil, will be absorbed, in large part, by the overarching plasma vortices 34, 34′ and 34a, 34a′, FIG. 1. Said overarching plasma vortices are covered by a Langmuir sheath 36, 36′ and 36a, 36a′, FIG. 1. Said overarching plasma vortices and Langmuir sheath, can absorb said electromagnetic radiation emitted by the inductance coil. When referring to plasma vortices, it can be assumed they are covered by a Langmuir sheath as this occurs naturally.

Said electromagnetic systems will be accompanied by plasma systems operating concurrently, said plasma systems include: vortex plasma produced by the uninsulated annular ring 2, 2′, and the plasma produced by large capacitors. Said plasma produced by large capacitors is used in large part in formation of plasma fields 34, 34′ and 34a, 34a′, FIG. 1. The uninsulated annular ring 2, 2′, produces most plasma.

As the electric system of the aircraft is fluctuating direct current, with inductance and capacitance, there will be an alternating current component. The current appears to move in one direction, but the current will be moving in two directions. The moving alternating current magnetic field, combined with a moving diamagnetic plasma current, magnetic field, encircling said moving particles, both fields cutting the same conducting field windings at multiple points, will generate a large amount of electricity. The initial torque in starting, evidently carries over and remains manifest in one direction, but the current is moving in two directions.

Referring to FIG. 1, the encircling plasma fields of this craft will affect the steel hulled craft, the same as electric coils around a steel cored electromagnet. As the energetic charged particles rotate around the ferromagnetic craft there is a concomitant increase in the magnetic intensity of the ferrochromium steel hull of the aircraft. High magnetic fields will be approached by the aircraft in this manner. These high magnetic fields will translate into elevated electric fields and electric currents.

The preferred embodiment for material for said blades is conducting, tungsten cobalt zirconium material. This material tolerates high fields and high temperatures. The preferred embodiment for the field windings around said blades is tungsten wire. Said tungsten wire is a conductor and can tolerate high temperatures. On-going research has indicated that high field conditions are approached with tungsten's high magnetoresistivity. The resistance in the aircraft electric current carrying tungsten field windings, with the craft capacitance and inductance systems, form the electromagnetic portion of the craft oscillatory circuit. By connection of the rotating plasma vortices to the craft field windings in craft annular ring, the orbiting plasma fields become part of the craft oscillatory circuit along with the electromagnetic radiation emitted by the inductance coil, and absorbed by the overarching plasma vortices.

Tungsten also has the highest melting point of the metals, though usually hard and brittle, it can be made pliable with hammering or other process, rendering it suitable as a wire. The array of field windings 10, 10′, FIGS. 2 and 3, will wrap the blade cores 19, 19′, FIGS. 2 and 3. When referring to the blades under said field windings, said blades are called blade cores. Tungsten cobalt zirconium is preferred embodiment for material for said bladed ring assembly. When the ferromagnetism of the magnetic field of the smaller aircraft is lost at high fields, the tungsten based electric current in the bladed ring assembly will persist, and intensify. The diagmagnetic magnetic field of the plasma 34, 34′ and 34a, 34a′, receives energy from the applied magnetic field of the aircraft. The plasma field center mass 37, 37′, is shown in FIG. 1. Said center mass represents the plasma between Langmuir sheaths 36, 36a and 36′, 36a′.

After the ferromagnetism of the craft is lost at high fields, the magnetic field of the annular ring of blades assembly 2, 2′, will continue to increase to high fields. Said ring has a potential for an extended magnetic field beyond the ring magnetic field 49a, 49b, FIG. 5. The ring magnetic field is shown on both sides of aircraft in FIG. 5.

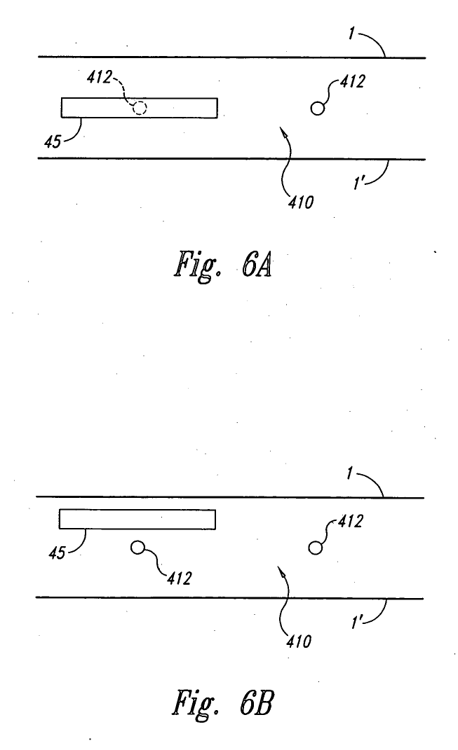

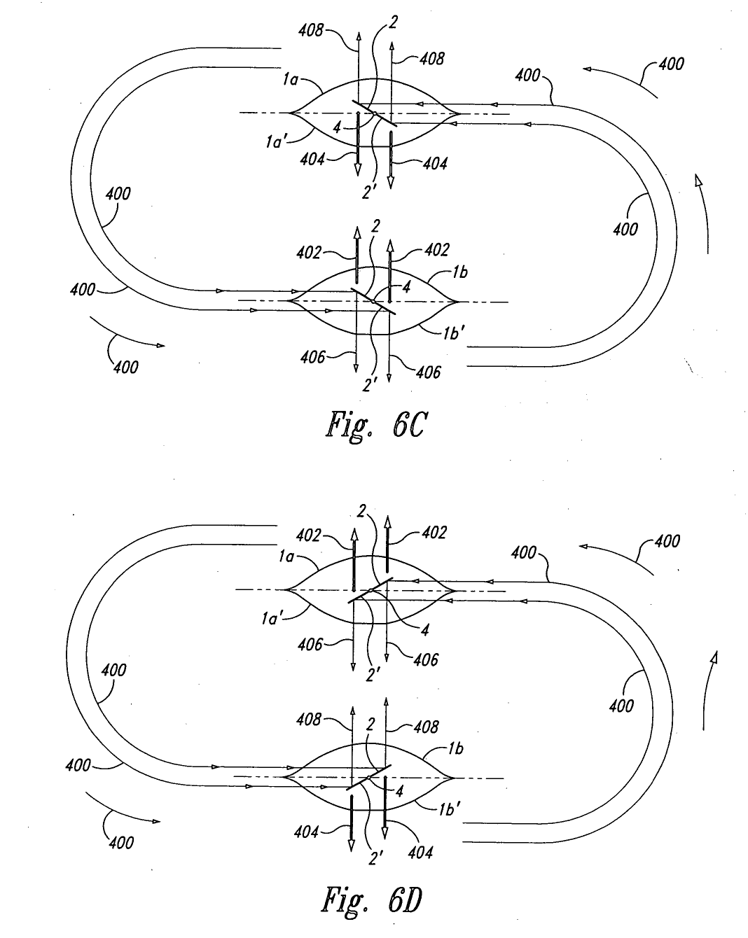

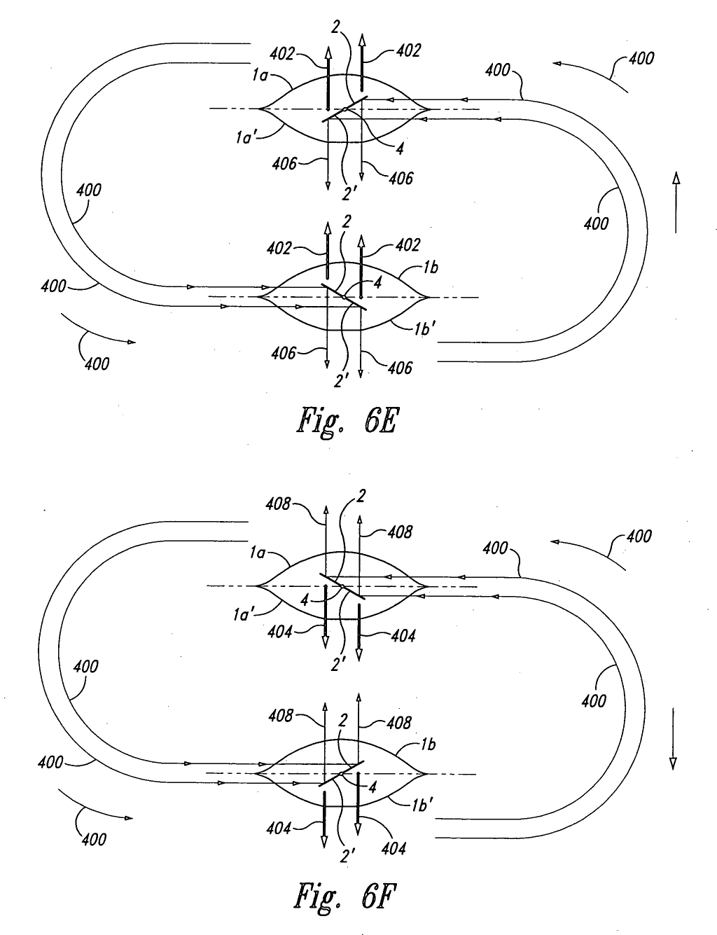

Referring to FIGS. 6C, 6D, 6E and 6F, the aircraft 1b and 1b′, is shown in a sideview showing the end of aileron 2 positioned over axel 4 in FIG. 6C. On the opposite side of aircraft 1b, 1b′, is aircraft 1a, 1a′, which is a cross section side view showing an aileron 2, on the exact opposite side to blade 2 on aircraft 1b, 1b′. The orbiting plasmas are rotating around the two halves of same aircraft. The particles impact aileron 2 on aircraft 1a, 1a′. The same path of orbiting particles 400 impact aileron 2 on aircraft 1b, 1b′, only this impact is on the opposite side. These are the two sides of same aircraft. This is a banking procedure for this single aircraft. One aileron is turned up as shown in FIG. 6C, the blade on the other side is turned up exactly the same, but the plasma, the particles are impacting opposite sides of these ailerons even though they are turned up exactly the same. The dark arrow to the right of figure in FIG. 6C indicates direction of banking movement. Similar directional arrows are to the right of figure in FIGS. 6D, 6E, and 6F, as well.

In conventional aircraft, one aileron is turned up and on the other side, the blade is turned down. The explanation for aircraft 6C, 6D, 6E and 6F, is, the particles are moving in opposite directions on each side of the aircraft, as depicted in said figures. The ailerons are conducting, the blades possess a charge. The dominate, charge of the ailerons is negative from electric current in field windings on the ailerons. The negative current attracts the large positive charges, and repels the negative charges with repulsive force. The large attraction for positive charges results in impacts on the negative charged ailerons as shown within FIGS. 6C, 6D, 6E and 6F. The equally significant repulsive force against the equally fast, if not faster, electrons, is met by a combined repulsive force between the two negative charges. Abrupt maneuvering, much faster than aerodynamic forces on a conventional aileron, are realized by electric forces on this aileron.

The opposite side of impacted aileron is not facing particle flow 400 to the same degree, effect is less.

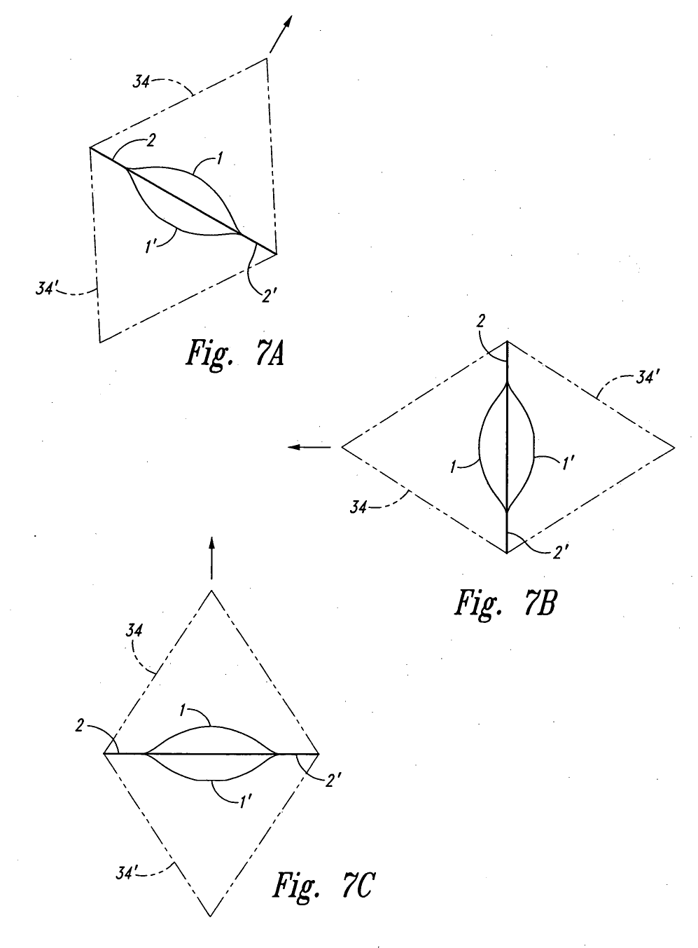

Referring to FIGS. 7A, 7B and 7C, propulsion or flight by use of rotating vortices of the plasma fields 34, 34′, FIG. 1, is shown. By utilizing ailerons for positioning the aircraft, as shown in FIG. 7A, and by increasing energy from the capacitance or inductance systems to the vortices 34, 34′, thereby increasing rotation of vortices, motional flight can commence. The plasma gun can assist in propulsion where needed.

The directional movement of said aircraft in FIGS. 7A, 7B, and 7C is in direction as indicated by arrow.

Extreme speed is possible with this mode of flight. Increase in vortex rotation leads to a lengthening of said vortex.

Referring to FIGS. 7A, 7B and 7C, descent mode for rotating vortex method of propulsion begins with a descent in altitude. Flight to intended landing site is similar to a helicopter maneuver for landing. Stopping directly over intended descent site, rotation of the vortices is slowed, slowing in rotation of vortices will rock the craft from side to side as craft slows. Ailerons 2, 2′, FIGS. 2 and 3, can be utilized to navigate the craft during descent.

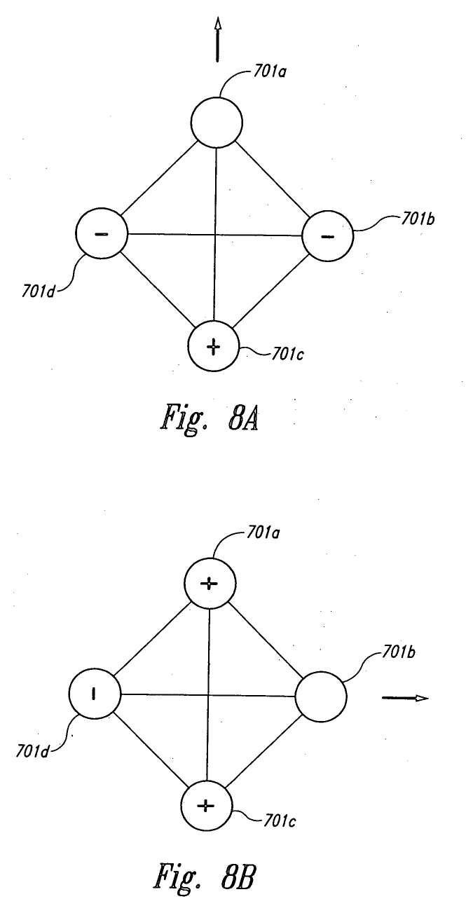

Referring to FIGS. 8A and 8B, utilizing capacitors as electrodes, with the high fields this craft will develop, does become feasible. It is expected this will be an emergency landing option. It is expected this form of propulsion will permit the craft to move at a slow rate of speed, as an emergency propulsion option. The craft can then be slowly landed.

Aluminum material is preferred embodiment for material for capacitors, magnesium is recommended.

A vacuum exists below the vortices, and as a dielectric for the capacitors will permit a high breakdown voltage. A preferred embodiment for dielectric for the capacitors is titanium dioxide compound. Said compound can be applied to the capacitors.

To date an adequate explanation of the underlying principle for capacitor propulsion or asymmetrical capacitor thrusters has not been forthcoming.

A most basic aspect of electric fields is being misinterpreted, applicant believes what is being observed is, a positive charge in an electric field experiences a force making it move in a direction where the potential is decreasing.

Evidently, no new physical principles are involved in this form of propulsion by means of capacitors, or asymmetrical different sized, or shape, capacitors.

Due to the large capacitor potential of said aircraft, capacitor propulsion will adequately serve as an emergency propulsion system within an atmosphere. Adequate to maintain said aircraft in a stable, slow moving state, while craft is slowly landed.

The craft will also be invisible to radar as plasma absorb all electromagnetic radiation, including the radiation they produce. An insulated trailing wire outside the plasma vortices will be required to receive or transmit signals or visual spectrum. Said trailing wire will hang below said bottom vortex, and should be uninsulated a short distance below said vortex. An antenna can be deployed above the magnetic north pole of the craft—electromagnetic radiation is polarized and visible.

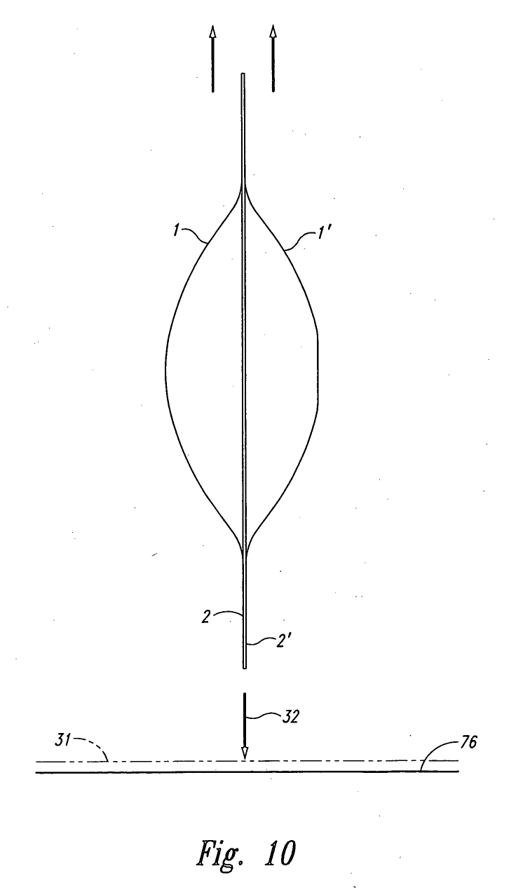

Referring to FIG. 10, the aircraft is shown in a perpendicular position relative to Earth 76. In this position the electric field 32, FIG. 10, of the craft is interacting with earth's magnetic field 31 at a ninety degree right angle, resulting in maximum repulsive force between the craft's electric field and magnetic field of the earth. The high fields of this aircraft, make this form of propulsion possible. Extreme acceleration perpendicular to the earth is possible. In another mode of propulsion, when the magnetic field of the craft is directed downward, when the craft is parallel with the earth, a high repulsive force between the positive charge on the bottom of the craft, and the positive earth, usually, is present. Also the magnetic field around the capacitor system as arrayed parallel with the earth, is also directed straight downward. As the magnetic field of the craft rises to high fields, said magnetic force contributes to the craft's rise off the earth.

The high magnetic field induced in aircraft by the rotating orbiting plasmas will also increase the electric field in bladed ring assembly 2, 2′, FIGS. 2 and 3. The chromium steel hull 1, 1′, FIG. 1, will be magnetized like the steel core of an electromagnetic. Said orbiting particles being the electric coils. Said particles will raise the craft to high fields.

Referring to FIGS. 4 and 5, an electric system 20, FIG. 4 connects the capacitance and inductance systems and the extensive connecting electric wiring of the craft to the engineer control panel 540, FIG. 5, located behind the pilot area 113, FIG. 5, in engineer area 114. Said engineer panel will contain diagnostics for plasma and electric controls. Instruments and gauges 542 for pilot aircraft control are the same as other dynamic aerodynamic craft, and will include flight control systems 539, FIG. 5.

The aircraft 1, 1′, will be controlled by the electric system 20, FIG. 4. When energy in the capacitance electric system is depleted, energy will be obtained from the connected magnetic energy storage in the inductance system from the connected inductance coil. Deck floors 96, 96′, FIG. 5 are carbon graphite material.

Energy produced by the rotating plasmas raising the ferromagnetic craft to high fields, will be stored within the inductance system and the applied magnetic field of the craft. The 32 sets of capacitor plates, comprise 64 individual plates. The 32 blades in the ring of blades have a weak current entrance and a strong current exit, 64 openings. The appropriate plate will be connected to an appropriate opening in a blade, 64 plates to 64 blade openings.

Referring to FIGS. 2 and 3, tungsten field windings 10, 10′, are shown wrapped, around blade 2, 2′, in bladed ring assembly 2, 2′. Said field windings are wrapped around a blade core 19, 19′, comprised of tungsten cobalt zirconium material. Said blade core will be sharpened on the longitudinal edge 17, 17′; on both longitudinal sides of each blade in said bladed ring assembly 2, 2′. The sharpened edges will permit electric current from the uninsulated tungsten field windings 10, 10′, to be electrically conducted through said blade cores 19, 19′, forming a diamagnetic electric current moving through said blade cores, and a diamagnetic plasma current on top of said blade cores. Said circular electricity moves through all the blades around said aircraft. The currents move between all of the blades due to the electric wind effect, and due to the diamagnetic plasma currents normal current flow. The electric wind effect penetrates through air space 18, 18′, between longitudinal sides of said blade edges 17, 17′.

The field windings wrapped around blades 2, 2′, at blade ends 45, 45′, are wrapped longitudinally around said blades, permitting a pinch effect on ions and electrons released and energized by the uninsulated field windings high voltage. The field windings are wrapped around blade cores 19, 19′, at blade notches 7a, 7a′, 7b, 7b′, 7c, 7c′, 7d and 7d′. Weak electric current 9a, 9b′, will enter the field windings at the weak current entrance, and a strong current 9b, 9a′ will exit at the strong current exit. Incipient combustion and fire suppression nozzles 30, 30′, are shown inside sharpened lip 5, 5′.

The sharpened lip on the edge of hull 1, and hull 1′, permits accumulated pooled current of opposite charge to be safely exhausted onto the bladed ring assembly, preventing a flash-over. The sharpened hull edge, also manifests the electric wind effect. Window 25a, FIG. 3, is for the pilot and co-pilot. Window divider 15, separates area of assignment for pilot and co-pilot, Window 25b is for plasma electric engineer.

The three legs comprising the landing gear 6a, 6b and 6c, are shown arrayed on the bottom of hull 1′, around soft landing surface 43, and arrayed around slag removal hole 41′. The aircraft 1, 1′, and larger versions of said aircraft with a differing hull material composition, will discharge accumulated slag through the slag removal hole 41′, and into the ocean or other suitable disposal site. Said slag is a natural by-product of plasma fusion operations, and operation of the plasma based aircraft. More exactly, the slag produced also contains airborne contaminates as well as metallic residue. A slag mass is a more exact characterization of said waste material, more correctly referred to as slag mass, but herein referred to as slag, for brevity. The slag removal hole 41′, is also used as the crew access tube 41, 41′, FIG. 5.

Operation of the plasma based aircraft has reduced the plasma surrounding aircraft to its constituents, mostly electrons and protons, and in the process removed the contaminant residue, slag mass, comprising CO2, alumina, silicates, and other residue referred to as airborne contaminants and the causitive factors in global warming. The remaining atmosphere utilized within the plasma vortices, will be recycled back into the atmosphere purified of contaminants.

As the aircraft does not require any contaminating fuel to operate, it utilizes only the energy within the atmosphere, as plasma to operate, and in the process of operating, removes contaminants within the atmosphere. It is the ideal means whereby carbon dioxide, CO2, can be removed from the atmosphere. Said aircraft is a decontamination device.

The aircraft by itself will reduce global warming effects. In conjunction with said fusion process, a process portion of this patent, it can almost totally end said warming effects.

End of operation section of aircraft preferred embodiment.

Beginning a description of the preferred embodiment of aircraft.

Referring to FIGS. 1, 2, 3, 4 and 5, a preferred embodiment of the Multi-Functional Aircraft (MFA), also called aircraft, craft, or device is shown. The aircraft is comprised of a body hull 1, 1′, FIG. 1, comprising a top half hull 1, FIGS. 1 and 2, as well as bottom half hull 1′, FIGS. 1 and 3. A bladed ring assembly 2, 2′, FIGS. 1, 2 and 3, is mounted between the top and bottom half hulls 1 and 1′. An individual blade 2, 2′, is shown in FIG. 4, at 12 o'clock in ring system, attached to axel 4, FIG. 4, and said axel to blade attachment ring 16, FIG. 4, to connecting portion of the blade attachment ring 16. All 32 of the blades in bladed ring assembly 2, 2′, are pivotally attached to blade attachment ring 16. The bladed ring assembly 2, 2′, is connected to said capacitors by electric system 20, FIG. 4. Said capacitors are in turn connected to electric system 20, FIG. 4.

Said electric system 20, further comprises capacitor plates 701a, a′, 701b, b′, 701c, c′, 701d, d′, and 702a, a′, 702b, b′, 702c, c′, 702d, d′, and 703a, a′, 703b, b′, 703c, c′, 703d, d′, and 704a, a′, 704b, b′, 704c, c′, 704d, d′, and 705a, a′, 705b, b′, 705c, c′, 705d, d′, and 706a, a′, 706b, b′, 706c, c′, 706d, d′, and 707a, a′, 707b, b′, 707c, c′, 707d, d′, and 708a, a′, 708b, b′, 708c, c′, and 708d, d′, FIG. 5.

Said capacitor system in FIG. 5 is connected by electric system 20, FIG. 4, to the top and bottom of inductance coil 47, 47′, FIG. 5.

Said capacitor system in FIG. 5 is interconnected by electric wires 801a, a′, 801b, b′, 801c, c′, 801d, d′, and 802a, a′, 802b, b′, 802c, c′, 802d, d′, and 803a, a′, 803b, b′, 803c, c′, 803d, d′, and 804a, a′, 804b, b′ 804c, c′, 804d, d′, and 805a, a′, 805b, b′, 805c, c′, 805d, d′, and 806a, a′, 806b, b′, 806c, c′, 806d, d′, and 807a, a′, 807b, b′, 807c, c′, 807d, d′, and 808a, a′, 808b, b′, 808c, c′, and 808d, d′, FIG. 4.

The four quadrants of said electric wiring system 20, FIG. 4, comprise quadrants 60a, 60b, 60c, and 60d, comprising wiring between said adjacent capacitors, FIG. 4.

Said electric system 20, FIG. 4, also includes electric wires interconnecting said small capacitors 70a, 70a′, 70b, b′, 70c, c′, 70d, d′, 70e, e′, 70g, g′, and 70h, hl, FIG. 5 and FIG. 9A.

Said small capacitors are connected in parallel.

Insulated copper wire is preferred embodiment for craft wiring system. Thick wire is preferred embodiment for inductance coil. Enamel insulation is preferred insulation for inductance coil.

Also within the electric system 20, is the electrolysis system FIGS. 12D and 12E. The ferromagnetic cores 112a, 112b, 112c, 112c, 112d, 112e, 112f, and 112g, FIG. 12E, part of the electrolysis system FIG. 12E, will increase in magnetic intensity due to ions orbiting around said ferromagnetic cores, this feature is a principle part of the fusion process, as it permits particles exiting onto roof of said ferromagnetic craft, to coalesce into a spherical plasma.

Said capacitor system FIG. 5, is further connected by electric system 20, FIG. 4, to the top and bottom of the inductance coil 47, 47′, FIG. 5.

Referring to FIG. 1, the top most point on top vortex 34, is apex 55, on bottom vortex 34′, the bottom most point is base 55′. An extra sharp edge of the hull, a hull lip 5, 5′, permits accumulated pooled current, electric charge on top and bottom hulls of craft, to be exhausted onto the annular ring surface 2, 2′, preventing flash overs of opposing charges. The set of blade notches 7a, 7b, 7c, 7d and 7a′, 7b′, 7c′ and 7d′ FIGS. 2, 3, and 4, best seen in FIG. 4, are for field windings 10, 10′, FIGS. 2, 3 and 4. The electric current enters field windings at weak current entrance 9a, FIG. 2 and exits at strong current exit 9a′, FIG. 3. Said weak and strong currents are best seen in FIGS. 2 and 3.

The applied magnetic field has non-moving poles, with fluctuating direct current with an alternating current component.

Said field windings 10, 10′ will wrap blade cores 19, 19′, FIGS. 2 and 3. Said blade cores will be comprised of tungsten, cobalt zirconium material. Said blades 2, 2′ also act as ailerons 2, 2′ for navigation of aircraft. Nozzles 30, 30′, FIGS. 2, 3, and 4, best seen in FIG. 4, placed between blades, are above and below blades on the hull exterior surface 1, 1′. Said nozzles are to extinguish fire or incipient combustion forming on blades due to high temperatures. Said nozzles, also, as conceived is an opening at the end of a hose by accepted definition. Openings 410, FIG. 6B, are to extract or replace blades through said opening. Landing gear 6a, 6b, and 6c are shown in FIGS. 1 and 3. Said landing gear can be extracted into or out of area within lower deck 96′, FIG. 5, and lower deck wall 8′, FIG. 5. Shown in FIG. 3 is soft landing surface 43, not requiring deployment of said landing gear prior to landing. Said soft landing surface is indicated by circular dash lines on bottom of craft hull 1′, FIG. 3.

Referring to FIG. 5, circular magnetic field 49a and 49b, surround blade assembly ring 2, 2′. An upper deck floor 96 and a lower deck floor 96′ are shown. The top of the electric system 20, is shown on planar surface of the top of the bottom half of hull 1′. Interior walls 8, ′, of hulls 1, 1′, are covered with an octagonal structural frame of beehive configuration with insulation and material to withstand temperatures of outer space, and the intervening thermosphere. Cabin doors are shown for access to lower and upper deck. Access to cabin door 26b to lower deck 96′, and access to upper level through cabin door 26a is from crew access tube 41, 41′, for both cabin doors. Said crew access tube is a hollow cyclinder, and also serves as a central support shaft 41, 41′, for both upper and lower hulls. The crew access tube 41, 41′, also serves as a surface for inductance coil 47, 47′, and serves as a slag removal hole 41, 41′. Said central shaft also has recessed, curved hand and foot bars 57, for ascent and descent within said tube, during entrance or exit from crew hatch doors 23a and 23b, on top of top hull 1, and bottom of bottom hull 1′.

Referring to FIG. 5, the pilot window 25a, is comprised of glass comparable to a deep diving bathysphere glass window. Similar glass comprises rear window 25b. Said window 25a is for pilots, rear window 25b is for the plasma engineer and crew. The pilot and co-pilot share the same window. Said window will be divided by a center line 15, FIG. 1, to delineate areas of assignment for pilot and co-pilot. The applied magnetic field is formed from magnetism remaining in chromium steel hull 1, 1′, and from the magnetic poles formed by the craft inductance coil. Said hull is similar to an automobile bumper in that it will reflect the firmament, sky. When entering crew access tube 41, 41′, said crew must wear heat resistant, non-conducting suits and gloves with helmets. Extreme ionizing effect will persist after departing craft through said shaft. Higher ferrochromium steel is also a recommended material for said aircraft hulls.

Referring to FIG. 5, engineer control panel 540 is located on upper deck in engineer area 114. Said panel will contain diagnostics for plasma and controls for said plasma, and also gauges and controls for the capacitor based electric system 20, FIG. 4.

Instruments and gauges 542, FIG. 5, for pilot aircraft control, and flight control systems 539, FIG. 5, will be located in pilot area 113, FIG. 5.

As said aircraft is also an aerodynamic aircraft, it will utilize the same instruments, gauges and flight control systems used by other aerodynamic aircraft, which includes modern, jet propelled aircraft. Said controls are electric based controls. The aircraft will use the capacitor based electric system, and when the capacitance system is diminishing in energy, the magnetic energy stored in the inductance system will be used.

The aircraft electric system 20, controls the amount of energy going to the field windings, thereby controlling the number of ions freed to the vortices, thereby controlling the vortices. The amount of energy to or from the vortices will be controlled by said electric system and connected magnetic inductance system.

The Larmor orbiting particle plasma field 34, 34′ and 34a, 34a′, FIG. 1 is produced by electrons and ions from the uninsulated bladed ring assembly 2, 2′, FIGS. 2 and 3. Said ions depart said assembly ring with a Lorentz force, being projected at right angles to the magnetic and electric fields of said aircraft, said fields being at right angles to each other. Said charged particles, are then projected into perpendicular Larmor gyro orbits around said craft within the applied magnetic field of aircraft. Charged particles along the length and width of said bladed ring assembly will be emitted. Ions will also be produced en mass by collision or heat. Said formed plasma field, above and below the bladed ring assembly, will be the length and width and circumference of said bladed ring assembly. Said plasma fields will be turning to the right when viewing craft in the air from the ground looking up. Both the top vortex 34, 34a, and bottom vortex 34′, 34a′, will be turning to the right. Therefore, the motional direction for movement of the aircraft, by the right hand rule, is upward, for both the bottom and top vortex, fixed within craft magnetic field.

The orbiting particle field 34, 34′ and 34a, 34a′, FIG. 1, is covered by a Langmuir sheath 36, 36′ and 36a, 36a′, FIG. 1. A vacuum 3, FIG. 1, within center of space above hull 1, FIG. 1, forms, facilitating formation of a fusion spherical plasma. Said vacuum 3, 3′, FIG. 1, is between orbiting particle field 34a, 34a′, FIG. 1, and the hull 1, 1′, FIG. 1. Said vacuum forms in this area immediately upon formation of said Larmor particle, plasma vortices. The vacuum persists. Upon formation of said vortices, the emitted electromagnetic radiation 44, 44′, FIG. 5, emitted from inductance coil 47, 47′, FIG. 5, within said vacuum, is absorbed, as said plasmas absorb all electromagnetic radiation. When this craft lands in an area with small water deposits on the earth, or elsewhere, said small ponds will freeze over, even in the summer. This is a vacuum effect. Area between the hulls is also a vacuum 3, FIG. 1, center of aircraft between the hulls 1, 1′, FIG. 1. The carbon graphite deck floors 96, 96′, FIG. 5, have a melting temperature of over 3000 degrees Centigrade.

Referring to FIGS. 2 and 3, blade 2, 2′, comprised of the materials tungsten cobalt zirconium, is wrapped by field windings 10, 10′, said field winding wire is comprised of the material tungsten. Said blade core 19, 19′, comprised of the material tungsten cobalt zirconium, will be sharpened on the longitudinal edges on both longitudinal sides, said longitudinal edges 17, 17′ of each blade in said bladed ring assembly 2, 2′.

Said sharpened edges will permit an electric current from said field windings to be conducted across, through said blade cores. Said circular current 14, 14′, FIGS. 2 and 3, is conducted through said blade cores between the outer edge of blade cores 13, 13′, FIGS. 2 and 3, and the hull surfaces 1, 1′, FIGS. 2 and 3, on said blade assembly ring 2, 2′. Said ring is best seen in FIG. 11A.

An electric wind effect will permit electric current to flow between blades separated by a short air space 18, 18′. Said air space is located between said blades, longitudinally, air space 18, 18′, FIGS. 2 and 3.

Said field windings are wrapped around blades at blade end 45, 45′, FIGS. 2 and 3. The edge between said blade ends and the blade assembly ring conducting electric current conducted around said ring, is ring edge 13, 13′, FIGS. 2 and 3.

A diamagnetic plasma current is also circling on the top surface of said conducting ring 14. The diamagnetic plasma current is an extension of said plasma vortices.

A slag removal hole 41′, FIG. 3, permits removal of accumulated metallic residue, airborne contaminants, and fusion reaction slag. The hole 41′, is positioned at the end of crew access tube 41, 41′, FIG. 5.

The three legs comprising the landing gear 6a, 6b and 6c, are shown arrayed around the bottom of said aircraft in FIG. 3. Also shown is a soft landing surface 43, and said slag removal hole 41′, FIG. 3.

The positioning of the two rows of longitudinally placed field windings 10, 10′, FIGS. 2 and 3, will permit a pinch effect to exist between said pairs of field windings on each blade, and a pinch effect also exists between adjacent field windings on blades that are adjacent. Specifically, the space between a single longitudinally placed field winding on one blade, and the longitudinally placed field winding on the next plade. The intervening space also manifests a pinch effect.

Said aircraft to include varients of said aircraft, larger or of a different material composition, also possess a decontamination potential of significance. The claimed operation of said aircraft, also manifests capability to not only ameliorate global warming, but in a larger sense, to solve global warming. If economies would utilize applicant's invention for transportation and electric energy generation, global warming might end.

Referring to FIG. 6A, a plurality of holes 412 through blade attachment ring 16, FIG. 4, to insert a plurality of axels 4, FIG. 4, is shown. Said axels are attached at the opposite end to a plurality of blades 2, FIG. 4, forming a bladed ring assembly of 32 blades, 2, FIG. 4. Said holes 412, FIG. 6A, will be insulated to insulate axel 4 from blade attachment ring 16. Said axel 4 attaches to blade end 45, FIG. 6A of blade 2 through hole 412 as shown by lead line to hole 412, FIG. 6A, located behind the center of blade end 45, FIG. 6A. Also shown is opening 410, FIG. 6A, to extract worn or burnt blades through area between the hulls 1, 1′, FIG. 1. Said area comprising opening 410, FIGS. 4 and 6A.

Referring to FIG. 6B, blade end 45 FIGS. 2 and 6B, is shown in opening 410, FIG. 6B, between hulls 1, 1′, FIG. 1, being removed above hole 412, FIG. 6B, as a smoking or worn blade to be replaced.

Referring to FIG. 6C, a single aircraft is shown. A side view of half of craft 1b, 1b′ and a cross section of the remaining half of the craft 1a, 1a′, are shown. The front half of blade is slanted downward, the rear half of blade is turned up. Moving charged particles 400 in orbits around said aircraft are shown. Particles 400 impact the bottom of blade on axel 4 of aircraft 1b, 1b′, and are reflected downward 406 on entire bottom portion of blade on axel 4. The bottom impact on aileron 2 by particles 400, produces an opposite and equal reaction and movement in opposite direction. The blade and aircraft, half of aircraft 1b, 1b′, are moved upward. On the opposite side of aircraft 1a, 1a′, orbiting particles are now moving in the opposite direction relative to aircraft 1b, 1b′. The aileron 2, 2′, FIG. 6C on aircraft 1a, 1a′, is in the same position as the blade 2, 2′, FIGS. 2 and 3, on the opposite side of aircraft 1b, 1b′. The moving particles 400 are now impacting the top of the blade and are reflected upward 408, simultaneously, the blade and aircraft are moved downward 404. This opposing movement on each side is a banking maneuver. It resembles conventional jet aircraft, but is an entirely new method of navigation. Though, the exact same controls and systems used on said jet aircraft, can be utilized on aircraft 1, 1′. The blade at axel 4 will move upward into a more energetic particle orbit, and the other half of blade will move downward into a more energetic particle orbit. The results will be instantaneous banking of the aircraft.

Referring to FIG. 6D, a single aircraft is shown. A split, front side view of aircraft is shown, and a cross section, split, rear side view of craft is shown at the top. The moving charged particles 400 are impacting the top of blade between axel 4. Particles are reflected upward 408, opposite opposing force is downward 404. The other side of same aircraft, a cross sectional view, shows the moving charged particles 400 impacting blades between axel 4 on the bottom. The particles are deflected downward 406, a reactive force upward 402, then banks aircraft upward on the left, assuming aircraft is traveling to the right.

Referring to FIG. 6E, the bottom craft shown is one side of an aircraft. An opposite cross sectional view of the side of the top aircraft is also shown. Both views, top and bottom, are of one aircraft. Charged particles 400 are impacting blade at axel 4 striking blade bottom, deflecting downward 406. The same particle orbit impacts the top aircraft aileron at axel 4 deflecting downward 406 with a reactive force upward 402. The aircraft will ascend in altitude. This operation is similar to the increase or decrease in altitude by the use of elevators on the tail of conventional jet aircraft. Said elevators are located in the tail section.

Referring to FIG. 6F, a moving charged particle field represented by arrowed lines is impacting aircraft 1b, 1b′, on the top of the aileron on axel 4, deflecting particles upward 408, with an equal and opposite reactive force downward 404. The orbiting charged particles impact aircraft 1a, 1a′, on the top surface of aileron on axel 4, deflecting downward 408 with an equal and opposite force downward on aileron and aircraft, 404. The aircraft will descend in altitude.

Referring to FIG. 7A, a field of Larmor gyro orbiting particles, orbiting around craft hull 1, 1′, is shown. The aircraft in FIG. 7A has been positioned in direction of the arrow by using ailerons 2, 2′, FIGS. 2 and 3. The rotating vortices will move aircraft in the direction indicated by arrow. Increased energy to rotating vortices 34, 34a and 34′, 34a′, will increase length of vortex 34′, 34a′, and increase the rotating rate of both the top and bottom vortex. Said increased energy will also increase the speed of aircraft.

Referring to FIG. 7B, an aircraft with hull 1, 1′ has been positioned horizontal relative to the earth, in direction of travel indicated by arrow. The aircraft has been positioned in a horizontal position by ailerons 2, prior to acceleration. The rotating vortices will move aircraft in direction indicated by arrow. Increased energy to rotating vortices 34, 34a, and 34′, 34a′, will increase length of vortices and also increase the rotation of both vortices, and will increase the speed of aircraft.

Referring to FIG. 7C, an aircraft is shown having been positioned in a vertical position by ailerons 2, 2′, FIGS. 2 and 3. Direction of travel has been indicated by arrow. The aircraft is perpendicular to earth. The aircraft has been positioned by ailerons 2, 2′, prior to acceleration. The rotating vortices 34, 34a, and 34′, 34a′, FIG. 1, will move the aircraft at increasing speed as rotating of vortices increases. The vortices will also increase in length as rotation increases.

Referring to FIGS. 7A, 7B, and 7C, descent mode for rotating vortex method of propulsion begins with a descent in altitude. Flight to intended landing site is similar to helicopter maneuver for descent. Stopping directly over intended landing site, rotation is slowed. The slowing in rotation of vortices will rock the craft as it slows. Descent is in vertical mode, FIG. 7C. Ailerons can be used in descent to level aircraft.

Referring to FIG. 8A, motional movement of an aircraft by using an array of capacitors is shown. In this instance, the capacitors are performing as electrodes, specifically, said large capacitors 701a, 701b, 701c, and 701d, within FIG. 8A. Said large capacitors 701a, 701b, 701c, and 701d, within FIG. 8A, said array could contain more electrodes, in correct arrangements. In FIG. 8A, the single capacitor 701c is indicated as being positively charged, and capacitor 701d and 701b, negatively charged. Capacitor 701a does not have a charge. Direction of movement will be as indicated by arrow, in this example, in the direction of more highly charged electrode 701d and 701b.

Referring to FIG. 8B, the capacitor electrodes 701a and 701c are indicated as more highly charged than the oppositely charged capacitor electrode 701d.

Electrode 701b does not have a charge. Movement will be in the direction of more highly charged electrodes as indicated by arrow. The fluctuating direct current utilized by the capacitance system, is a positive factor applying potentials.

The capacitors are of a circular configuration.

Referring to FIG. 9D, the aircraft used as a space craft, is shown. When said craft enters a gravity free area in space, hulls will be closed after the blade system has been retracted into craft. The blades will be retracted to form two levels of retracted blades, each level containing 16 blades, for a total of 32 blades, but only The top level of 16 blades is evident in FIG. 9D. Both levels of blades can be connected to tubes inserted in axel holes forming full diameter holes between hulls, or only one level, the top level, will be used in preferred embodiment. Said tubes connected from the small capacitors to the large capacitors, and then said tubes will be projected through said axel holes, and eject particles for propulsion in space. Said particles will be accelerated by alternating current in the alternating current component of the fluctuating direct current of the craft. Usually, alternating current consumes a disproportionate amount of energy for effect desired, but in this craft, it is part of the existing electric system. Axels 4, are shown in FIG. 4.

In space the small capacitors 70a, a′, 70b, b′, 70c, c′, 70d, d′, 70e, e′, 70f, f′, 70g, g′ and 70h, h′, will be connected to large capacitors 701a, a′, 701b, b′, 701c, c′, 701d, d′, and 702a, a′, 702b, b′, 702c, c′, and 702d, d′, by connecting tubes for particle propulsion 80a, 80b, 80c, 80d, 80e, 80f, 80g, 80h, 80i, 80j, 80k, 80l, 80m, 80n, 80o, and 80p, FIG. 9D. The connecting tubes will insert through axel holes arrayed under 16 of the 32 blades in the bladed ring assembly 2, 2′, FIGS. 2 and 3. The unused axel holes will remain plugged, in preferred embodiment. Axel holes 412, are shown in FIG. 6A.

The tubes inserted in the axel holes will project particles into space for propulsion, said particles accelerated by an alternating current, repulsive charge to accelerate particles.

An accelerated particle-stream 83, FIG. 9D, is shown on the opposite side of craft from the arrows indicating direction of travel for said aircraft, said direction of travel being a reaction from said accelerated particle stream in the opposite direction, at accelerated particle exit hole 413m, FIG. 9D.

In space the accelerated particle exit holes 413a, 413b, 413c, 413d, 413e, 413f, 413g, 413h, 413i, 413j, 413k, 413l, 413m, 413n, 413o, and 413p, will be connected to connecting tubes for particle propulsion 80a, 80b, 80c, 80d, 80e, 80f, 80g, 80h, 80i, 80j, 80k, 80l, 80m, 80n, 80o, and 80p, FIG. 9D.

Said accelerated particle stream 83, FIG. 9D, is shown exiting from exit hole 413m in FIG. 9D.

Said accelerated particle stream 83, can be instantly shifted to any of the accelerated particle exit holes, also called exit holes, around the circumference of said aircraft.

By means of said array of exit holes, the aircraft is enabled to instantaneously change direction of travel to avoid an instrument sensed on-coming object in space. The available large number of possible directions of travel by means of said exit holes, is required when it is realized, unlike on earth, objects can arrive from under the craft, as well, 180 degrees in any direction from under the craft, as well as 180 degrees in any direction above the craft. Said plasma gun can be utilized for vertical control of space craft maneuvers.

Each of said tubes, arrayed around interior of craft, 16 tubes, can be used as a particle propulsion system in space, instantaneously, to avoid oncoming objects in space, or for navigation in space. An accelerated particle stream 83, FIG. 9D, is shown.

The preferred method for storing said plasma for particle propulsion, is by storage in the bast array of capacitors. Said plasma stored as metal ions in said plates will be used for particle propulsion in space. Circling plates under craft charges plates.

Said aircraft can attain high speeds, near the speed of light, over time, months to a year. For shorter trips, to Mars or the asteroid belt, a trip may only take two or three months. Half of the time accelerating, and the other one half, decelerating.

Referring to FIG. 9E, the aircraft used as a submersible craft is shown. Said submersible craft is depicted with blades extended. The blades 2, FIG. 2, used as propellers 666, FIG. 9E, are shown. Said blades 2, are rotatable 360 degrees when used as ailerons 2, FIG. 6C, and are also rotatable 360 degrees when used as propellers 666, and will be rotated at propeller end 667, with the magnetic and electric fields of the craft at right angles, ions will be projected at right angles to both fields with a Lorentz force directed against conducting water, thereby propelling said submersible craft, said propellers also propelling craft.

Energy for said propellers is stored in inductance system and in the capacitor plates in said array of capacitors. Said propellers will revolve slowly, in a synchronized manner, whereby craft will be propelled in a straight path, and at the same time slowly revolve.

Said rotating propellers will be used for propulsion, and also to navigate said submersible craft.

For rapid egress from an area, an onboard plasma gun 64, can be used for propulsion. Said plasma gun can be moved to any location around the circumference of the submersible craft. Said plasma gun receives energy stored in said array of capacitors. Plasma exit end 74, is shown.

Said plasma gun can also be used to navigate the submersible craft.

Upon impacting water from airborne flight, the craft hulls will be gravity closed. Upon leaving water, hulls will be gravity opened.

Axels 4, FIG. 4, will be closed positioned between precut half diameter holes on rims of each hull. Half of said full diameter axel hole will be on one hull, and the opposite half on the other hull.

The axels will be between the two half diameter holes on closing said hulls. Hulls will close together upon the axels.

Referring to FIG. 9F, a boring device is shown. The aircraft can be used as a boring device by attaching a drill 87, to the aircraft by positioning said drill through the craft central shaft 41, 41′, FIG. 5, and attaching the bottom of the drill to drill base plate 88b, said base plate attached to bottom of bottom hull 1′ of craft. A drill brace plate 88a, with a center hole to insert the drill through, is attached to the top of the top hull 1, of the aircraft. In a stationary mode, the aircraft can be used as a boring device. The aircraft has a approximate 25 degree rotation, and then an approximate one second halt, and then another 25 degree rotation, and an approximate one second halt. The halt is due to the oscillatory, pulsed, fluctuating direct current of the aircraft. The rotation explanation, is the following. The ferromagnetic craft is pulled into rotating by the magnetic field of the diamagnetic plasma current operating within said aircraft pulsed current. Said natural rotation of the craft can be used to rotate said drill attached to the aircraft.

Referring to FIG. 9G, the aircraft used as a lifting device is shown. The aircraft can be used as a lifting device by inserting titanium cross bars 888a and 888b, and attaching cables to the four ends of said titanium cross bars. Said attaching cables, cables 889a and 889b, are shown attaching by lifting hook 891, to load 892 in FIG. 9G. Said titanium cross bars can be inserted between said hulls, attached and sitting on top of the lower hull rim, curving around central shaft 41, 41′.

Referring to FIG. 10, the aircraft is shown positioned perpendicular with the earth 76. The aircraft is in the direction of the arrow toward the earth. The electric field 32 will interact with the earth's magnetic field 31, with a strong repulsive force. The high fields of the aircraft will make possible ascent with this form of propulsion.

With the aircraft applied magnetic field within an oscillatory circuit, with a stronger electric field than magnetic field, and with said plasma field and diamagnetic plasma current moving in a clockwise direction when viewed from the ground looking up, said fields will pull the positive particles, primarily protons in the direction of the electron current flow to the right.

I claim:

1. A multi-functional aircraft comprising: a ferromagnetic body hull, an annular ring of blades arrayed around said aircraft, said array of blades also called ailerons, before, said blades are wrapped by uninsulated field windings, said blades are called blade cores, blade cores, uninsulated field windings, an array of ailerons, an array of large capacitors and an array of small capacitors, field windings connected by conducting wires to an array of capacitors located within the interior of said aircraft, a method of producing free ions, free ions are produced on the current carrying field winding surfaces of the annular ring of blades, also called a bladed ring assembly, said annular ring of blades arrayed around the circumferential midsection of the aircraft, a method whereby ions are released from said uninsulated field winding surface areas, and then, said ions are energized and projected from the blade surfaces with a Lorentz force at right angles to the craft magnetic and electric fields, said fields at right angles to each other, an array of capacitors,
and then, said ions are projected into perpendicular, diamagnetic Larmor orbiting particle fields around the aircraft, perpendicular fields within the applied magnetic field of the aircraft, an electric wiring system, an electric system, a method whereby said Larmor orbiting particle fields form funnel shaped plasma vortices above said annular bladed ring, and below said bladed ring, within the aircraft applied magnetic field formed upon starting aircraft, by a method utilizing remnant magnetism in said aircraft, and from the capacitance and inductance systems in the craft oscillatory circuit, a top plasma vortex, a bottom plasma vortex, an applied magnetic field, an inductance system, an oscillatory circuit, a capacitance system, resistance from said tungsten uninsulated field windings connected to a copper wire based aircraft electric system, all of the aforesaid are claimed, and the following also are claimed,
a method whereby said aircraft can be lifted off the earth, other surface, and become airborne, a method whereby said craft will be raised to high electromagnetic fields, the Larmor orbiting particles are, in effect, the electric coil in an electromagnetic, and the ferromagnetic craft is, the magnetic core inside the electromagnet, the Larmor orbiting particles are increasing in speed to the speed of light, at the same time, the ferromagnetic hull of the aircraft is being raised to high fields, said high magnetic fields translate into high electric fields, a large amount of electric energy is produced within these electromagnetic fields, said energy is stored in the array of capacitors within the aircraft, and within the craft inductance system, and within the craft orbiting particle fields, the plasma vortices and the particle fields are diamagnetic, field windings, uninsulated conducting field windings, the aircraft, a fluctuating direct current with an alternating current component within an oscillatory circuit possessing an inductance coil and an array of capacitors,
also claimed, tungsten uninsulated field windings connected to an electric wiring system containing conducting wires, said craft has few moving parts except for a plurality of axels pivotally connected to the blades, axels fixed in place, and at the other end from attachment to the blades end, axels connected to an interior blade attachment ring, blade attachment ring, also fixed in place, and also does not move, other than electrically rotates the axels, which rotate the blades, blades used as ailerons, blades used as propellers underwater, other than the axels, the craft has no moving parts, said blades when turned by said, axels will also move, a craft not requiring fuel to be provided for the craft to operate, ions produced on the uninsulated field windings as the fuel for the aircraft, electrons as fuel for aircraft, an array of axels,
plasma obtained from the atmosphere as the fuel for aircraft, and plasma as the fuel required for travel in space by means of a particle, propulsion system in space, plasma as fuel required for submersible propulsion underwater, propulsion underwater by means of a particle propulsion system, and propulsion underwater by means of accelerated plasma, an on-board electrolysis system to electrolyze water and seawater,
axels that rotate individually, or synchronized, axels fixed in place, blades rotated by axels, a blade attachment ring, a means for navigation, a means for navigation, to include:
a flight control system, or systems, aircraft instruments, gauges for aircraft flight, a navigation and control system, a navigation system utilizing ailerons operating within moving charged particles, said charged particles are rotating around the aircraft within the atmosphere, a flight control system, instruments and gauges for aircraft control, a navigation and control system, a flight system utilizing ailerons possessing an electric charge within rotating vortices comprised of moving charged particles,
an array of small capacitors arrayed around an aircraft central shaft,
said shaft also serving as the crew access tube, said shaft also serving as containment tube for the inductance coil, said shaft also serving as a pressure release tube for a B-11 isotope ion nuclear fusion reaction on the top of the ferromagnetic craft, on the roof, said radiation reaction being essentially radiation free, and with negligible radiation being produced, a vacuum area, said vacuum area includes area between said aircraft hulls to include area containing the array of capacitors, a vacuum area as a dielectric permitting a high breakdown voltage for said capacitors, a means of propulsion by use of said rotating plasma vortices, a means of propulsion by use of said plasma gun, rotating plasma vortices as a means of propulsion, a plasma gun,
capacitors as electrodes as a means of propulsion, Propulsion by means of propellers to include conducting propellers transferring an electric potential to conducting water, and by means of the craft magnetic and electric fields, reacting against the conducting water with a Lorentz force directed at the conducting water from the craft, the craft magnetic and electric fields being at right angles to each other, and the Lorentz force being at right angles to the electric field and the magnetic field of the craft, a method for forming aircraft applied magnetic field upon starting aircraft,
said propulsion systems include navigation systems utilizing directional control of said propulsion systems, secondary navigational or propulsion systems being ailerons utilized as propellers underwater for navigation, for propulsion, a combination thereof, in an atmosphere plasma propulsion can be utilized, movement by means of capacitors, movement by means of a rotating plasma vortex mode of propulsion, all combinations of propulsion and navigation systems cited, said aircraft as a lifting device, or as a boring device,
a method of charging the capacitor plates with plasma for particle propulsion in space, by means of rotating said disengaged plates beneath said annular ring of blades of said aircraft, said bladed ring assembly encircling the aircraft is also called an annular ring, whereby said plates will absorb and store plasma for particle propulsion in space, a system to create an artificial atmosphere by means of utilizing an electrolysis system within said aircraft, a means of navigation underwater by use of said blades as rotating propellers, alternate means of propulsion, nozzles to extinguish incipient combustion or fire, on said blades, use of the aircraft for vertical takeoff and landing, a means whereby the aircraft are rendered invisible to visible and electromagnetic radiation due to the plasmas being opaque by nature to penetration by electromagnetic radiation, a means whereby by surrounding a craft in plasma vortices, the craft is rendered opaque to electromagnetic radiation, to include the radiation in the visible spectrum,
a means of viewing through said opaque plasma at magnetic poles where light is polarized, by means of using an antenna on roof of the aircraft, or viewing outside the opaque to electromagnetic radiation plasma by means of a trailing wire hung beneath the bottom plasma vortex, capability of said aircraft to be used within radiation belts above the earth, not otherwise safe to enter for even a limited period of time, capability of the aircraft to remain in said radiation belts for extended periods of time, capability of the aircraft to operate within outer space, to reach outer space, the exosphere and above, utilizing the same fuel, said fuel being energized ions utilized within the atmosphere on earth, or underwater on earth, and upon reaching outer space, to utilize a particle propulsion system for propulsion, a method for increasing the ferromagnetic magnetizm of the aircraft body hull, said craft is claimed as a decontamination device as it produces clean energy, A means of propulsion, now possible due to craft high fields, by positioning craft electric field at right angle to earth magnetic field, and increasing strength of said electric field, thereby, accelerating aircraft away from earth magnetic field, and away from surface of earth,
an annular ring of blades, said annular ring of blades is also called blade assembly ring, said annular ring of blades due to sharpening of the longitudinal edges of said blades, said sharpended edges will experience an electric wind effect, due to an electric wind effect, an electric current will be enabled to rotate around the peripheral midsection of said aircraft, the electric current formed primarily in the process of formation of plasma by the current in the field windings around said blades,
a plasma gun with a large pulsed current, and with a Lorentz force, said plasma gun also receiving a source of plasma from off said annular ring of blades connecting with said plasma gun, said ring of blades encircling said aircraft, said plasma being further accelerated by the diamagnetic plasma electric current entering said plasma gun with said plasma off said annular ring of blades,
Some of said propulsion systems, though widely known, were not heretofore feasible, but are now possible due to high field conditions attained by said aircraft,
said aircraft will possess aircraft controls based on the same general principles pertaining to other aerodynamic aircraft, to include jet aircraft, in effect, the aircraft is electrically controlled, aircraft pilots will be able to fly and operate this aircraft within the atmosphere, within an underwater environment in which said aircraft can operate, knowledge possessed by naval submarine pilots, will permit rapid comprehension of operation of said craft as a submersible craft, knowledgeable plasma engineers will accompany the craft as an aircraft, a submersible craft, and as a space craft,
in outer space, the exosphere and above, said aircraft used as a space craft will require celestial navigation, said knowledge is extant at this time, the aircraft used as a space craft, will utilize particle propulsion from plasma stored in said capacitors, metal ions, opposing capacitors of opposite charge, with an alternating current, will propel the particles in space, in space a co-axial rail accelerator can be utilized, said system is possessed by the aircraft, said retracted blades within aircraft, possess this capability, particle propulsion by expelling particles with a repulsive charge, can be utilized in space, in space,
a specially trained navigator for celestial navigation will be required, extant life support systems will be utilized, to include, recycled air systems, recycled water systems, food stores of dehydrated items and canned items, to last duration of trip, and a store of DVD's to last duration of trip, artificial gravity has to be induced by using small on-board machines, said machines have to be used daily,
a method of charging said capacitor plates with plasma for particle propulsion in space and underwater, by means of disengaging capacitors, and rotating said plates beneath the annular ring of blades, said disengaged plates will, thereby, absorb and store metal ions as plasma for particle propulsion in space, or underwater, said rotation of plates within the craft magnetic field induces a circular electric current within the plates, enabling plasma to be stored.

2. The aircraft as defined in claim 1, wherein hull of said smaller aircraft is comprised of the material chromium steel.

3. The aircraft as defined in claim 1, wherein said array of capacitors are comprised of the material aluminum.

4. The aircraft as defined in claim 1, wherein said inductance coil is comprised of thick coils.

5. The aircraft as defined in claim 1, wherein said plurality of blades in said bladed ring assembly, comprises approximately 32 blades.

6. The aircraft as defined in claim 1, wherein said blade cores are comprised of the materials cobalt, tungsten, zirconium.

7. The aircraft as defined in claim 1, wherein said uninsulated blade field windings around said blade cores are comprised of the material tungsten.

8. The aircraft as defined in claim 1, wherein said plurality of capacitors consists of approximately 32 large capacitors and eight small capacitors, said 32 large capacitors comprise approximately 64 large capacitor plates, and said eight small capacitors comprise approximately 16 small capacitor plates.

9. The aircraft as defined in claim 1, wherein said capacitors are connected in parallel.

10. The aircraft as defined in claim 1, wherein said means for navigation in the atmosphere will comprise said conducting ailerons operating by reacting against a field of highly charged particles.

11. The aircraft as defined in claim 1, wherein said capacitors utilize titanium dioxide compound as a dielectric.

12. The method of claim 1, wherein a method for charging said capacitor plates with plasma, metal ions, for particle propulsion in space and underwater, comprises,
(a) by means of disengaging said capacitor plates within a gaseous atmosphere, and,
(b) rotating said plates beneath the craft annular ring of blades, while said aircraft is stationary and aloft, whereby,
(c) said plates will absorb and store plasma as metal ions for particle propulsion in space or underwater, moving in said craft magnetic field, heat is generated due to induced electromotive force, and electric eddy currents flow in plates, storing plasma from atmosphere, said plates turning, rotating, as they rotate circumferentially around the bottom of said aircraft.

13. The method of claim 1, wherein a method of forming said aircraft applied magnetic field upon starting aircraft operation, will comprise the steps of:
(a) by means of utilizing remnant magnetism remaining within the aircraft ferromagnetic, chromium steel hull, from last period of operation, and,
(b) by utilizing the stored energy in the capacitance and inductance system, said system upon being put into operation, will therein,
(c) form a north pole at one end of the inductance coil, and a south pole at the opposite end, thereby;
(d) forming an applied magnetic field around said aircraft.

14. The method of claim 1, wherein a method for producing said aircraft rotating top and bottom plasma vortices will comprise the steps of:
(a) utilizing uninsulated field windings comprised of the material tungsten, and electric current to said field windings directed through insulated copper wires from an array of capacitors, resistance will be created in the less conducting tungsten wires, creating high temperatures,
(b) said high temperatures and the high voltage from capacitors, will occasion the release of free ions from the uninsulated tungsten field winding surfaces,
(c) said high temperatures on the tungsten wire surfaces in the process of producing ions, will produce an abundance of electrons, and consequent diamagnetic electric plasma current around the circular annular ring,
(d) at a voltage recognized to create charged particles, ions will be energized and depart the field windings as charged particles, with a Lorentz force at right angles to the electric and magnetic fields of the craft, said fields being at right angles to each other,
(e) utilizing said annular ring of blades with sharpended longitudinal sides permitting an electric wind effect between blades, said blades will thereby function as the base for a rotating circular ring current around said aircraft, and through and on top surfaces of said annular ring of blades, said current comprising released electrons in the process of forming said plasma vortices, and plasma moving diamagnetic with electric current around said aircraft,
(f) the aircraft electric system controls the amount of energy going to or from the field windings, by this means the electric system controls the amount of energy going into the forming plasma vortices, by means of direct input of energy through the field windings to the plasma, and thereby controls the energy in the vortices, and the rate of rotation of the vortices, and consequently, the speed of the aircraft,
(g) as the plasma in the vortices is a current carrying medium, the diamagnetic plasma current can receive direct electric current to this conducting medium,
(h) and, the converse is also true, in the same manner electric current can be removed from the diamagnetic Plasma current to the capacitance and inductance systems, slowing the craft,
(i) at a voltage to the field windings recognized to free ions, ions will be energized and depart the field windings, said ions now charged particles are then projected into perpendicular orbiting Larmor orbiting particle fields around the aircraft, forming a diamagnetic moving plasma field, with a conducting plasma current, due to strong diamagnetic plasma current, said field is rotating in a clockwise turning direction, when rotation of the plasma vortices is viewed from the ground looking up at the bottom of the craft, the craft vortices will be turning clockwise to the right, whereby, by the right hand rule, motional direction for movement is upward, and, after absorption of energy after a reaction, by said plasma vortices, the craft will lift off earth's surface,
(j) and, by positioning craft in desired direction of movement by means of said ailerons, and by increasing energy to said vortices, craft can be accelerated in desired direction of travel,
(k) prior ascent said craft will have to use plasma vortices, to accelerate craft in direction of travel.

15. The aircraft of claim 1, wherein a method for increasing aircraft electromagnetic fields, will comprise the steps of:
(a) upon starting operation of aircraft, electric energy stored in the capacitance system will be directed through copper wiring to the aircraft electric wiring system to tungsten wiring comprising field windings around the bladed ring assembly around said aircraft,
(b) said electric current through the lesser conducting tungsten field windings, will raise the temperature of said field windings to a high temperature, thereby releasing ions and electrons from said field winding surfaces, said released particles will be raised to high energy levels by the electric current in said field windings, said energized particles will be projected by a Lorentz force at right angles to the craft electric and magnetic fields, said fields being at right angles to each other,
(c) whereby, said projected particles will be projected into Larmor orbiting particle fields around the aircraft within aircraft applied magnetic field,
(d) whereby, by means of said orbiting particles, the aircraft ferromagnetic hull will be raised to high fields, similar to the electric coil around a ferromagnetic core in an electromagnet, and said core will be raised to high fields upon transmission of an electric current through said conducting coil,
(e) whereby, as said orbiting particles are increasing in speed to the speed of light, receiving energy from said applied magnetic field as well, said aircraft ferromagnetic hull will be raised to high magnetic fields, which translates into high electric fields and potential for high electric current.
